(19) United States
(12) Patent Application Publication
(10) Pub. No.: US 2015/0189045 A1
(43) Pub. Date: Jul. 2, 2015

(54) INFORMATION PROCESSING APPARATUS, DATA UPLOAD METHOD, AND COMPUTER-READABLE MEDIUM

(71) Applicant: CASIO COMPUTER CO., LTD., Tokyo (JP)

(72) Inventor: Nobuteru TAKAHASHI, Tokyo (JP)

(73) Assignee: CASIO COMPUTER CO., LTD., Tokyo (JP)

(21) Appl. No.: 14/573,114

(22) Filed: Dec. 17, 2014

(30) Foreign Application Priority Data
Dec. 27, 2013 (JP) JP 2013-270946

(51) Int. Cl. H04L 29/08

(52) U.S. Cl. CPC H04L 67/325; H04L 67/306

(57) ABSTRACT

According to a tablet terminal, a CPU uploads data specified as an upload target by an operating unit to a server apparatus at a specified timing if a parent account has been selected as an account to use, and automatically uploads predetermined data to the server apparatus at a predetermined timing if a child account has been selected as an account to use.

### BACKGROUND

1. Technical Field

The present invention relates to an information processing apparatus, a data upload method, and a computer-readable medium.

2. Related Art

A user account management function that sets user authority for a user account is conventionally known (see, for example, JP 2006-139522 A). With the known user account management function, a user can use the authority granted to him/her.

However, for example, when data created by a small child is uploaded to and managed in a server apparatus, even if the child is granted the authority to upload, the child has no idea of uploading, and cannot perform complicated operations, either. Hence, the child cannot upload data without troubling his/her parents, and may also fail to upload, which is inconvenient.

An issue of the present invention is to enable efficient data upload according to the account.

### SUMMARY

An information processing apparatus including: a control unit configured to create a first account to access a storage unit for managing data, and a second account corresponding to the first account; and a storage control unit configured to upload data specified as an upload target to the storage unit at a specified timing upon use of the first account, and automatically upload predetermined data to the storage unit at a predetermined timing upon use of the second account.

According to the present invention, it becomes possible to efficiently upload data according to the account.

### BRIEF DESCRIPTION OF THE DRAWINGS

FIG. 1 is a diagram illustrating an example of an entire configuration of a data management system in the embodiment;

FIG. 2 is a block diagram illustrating a functional configuration of the information processing apparatus of FIG. 1;

FIG. 3 is a block diagram illustrating a functional configuration of the server apparatus of FIG. 1;

FIG. 4 is a diagram illustrating an example of data storage of the account information storage unit of FIG. 3;

FIG. 5 is a flowchart illustrating a growth recording process A to be executed by a CPU of the tablet terminal of FIG. 1;

FIG. 6 is a diagram illustrating an example of a parent account login screen;

FIG. 7 is a diagram illustrating an example of a child account selection screen;

FIG. 8 is a flowchart illustrating a painting process executed in Step S10 of FIG. 5;

FIG. 9 is a diagram illustrating an example of a menu screen;

FIG. 10 is a diagram illustrating an example of a sketch selection screen;

FIG. 11 is a diagram illustrating an example of a drawing screen;

FIG. 12 is a flowchart of a Web screen display process executed in Step S12 of FIG. 5;

FIG. 13 is a diagram illustrating an example of a Web screen; and

FIG. 14 is a flowchart illustrating a growth recording process B to be executed by a CPU of the smartphone of FIG. 1.

### DETAILED DESCRIPTION

Hereinafter, a preferred embodiment of the present invention is described in detail with reference to the accompanying drawings. The present invention is not limited to the illustrated example

### <Configuration of Data Management System 100>

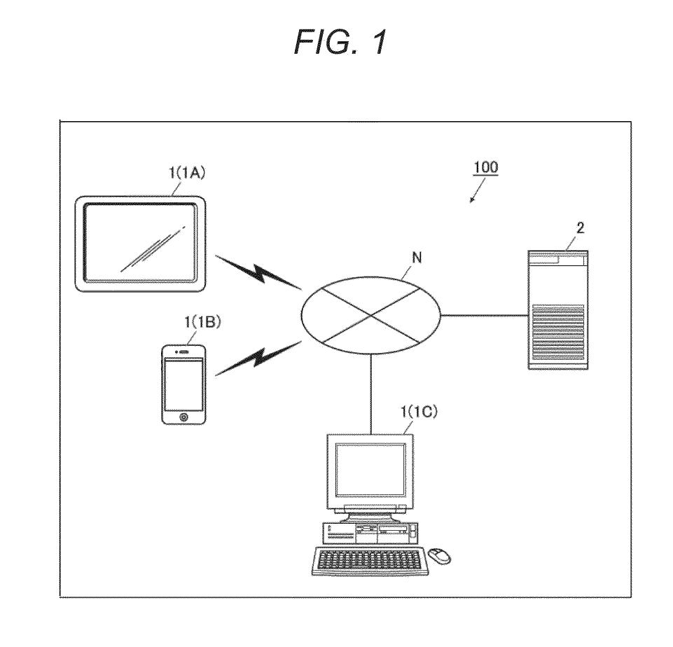

FIG. 1 is a diagram illustrating an example of an entire configuration of a data management system 100 in the embodiment.

As illustrated in FIG. 1, the data management system 100 is configured including information processing apparatuses 1 such as a tablet terminal 1A, a smartphone 1B, and a PC (Personal Computer) 1C, and a server apparatus 2. Each information processing apparatus 1 can connect to and communicate with the server apparatus 2 via a communication network N. The communication network N is, for example, the Internet line, and includes line networks that allow each apparatus to connect to the Internet line, such as a wireless LAN (Local Area Network) and a mobile communication network. The number of information processing apparatuses is not particularly limited.

The data management system 100 is a system that, when the information processing apparatus 1 uploads, to the server apparatus 2 that is storage unit, picture drawing data that a child has drawn on the tablet terminal 1A, and the child's growth records such as the child (family)'s still and moving images, saves and manages the uploaded data in the server apparatus 2, and provides the uploaded data in a viewable manner at the request of the information processing apparatus 1.

### <Configuration of Information Processing Apparatus 1>

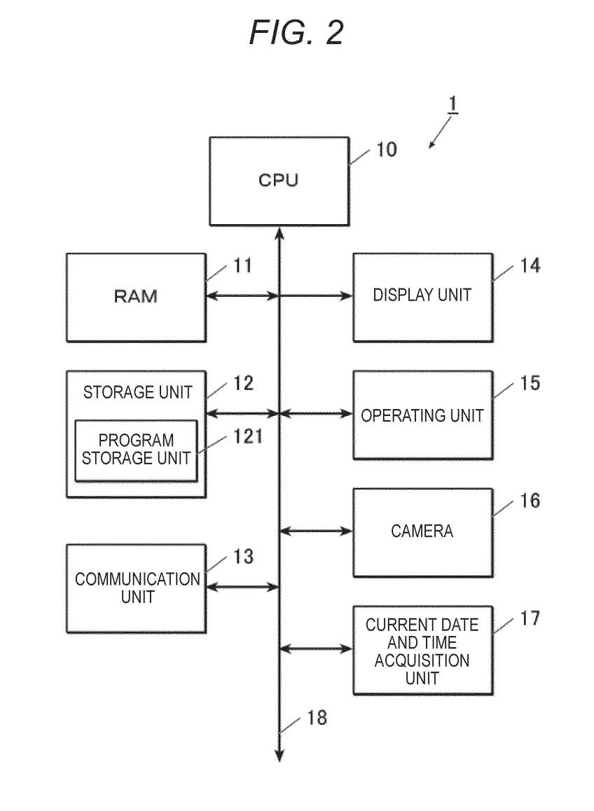

FIG. 2 illustrates an example of a functional configuration of the information processing apparatus 1. As illustrated in FIG. 2, the information processing apparatus 1 is configured including a CPU (Central Processing Unit) 10, RAM (Random Access Memory) 11, a storage unit 12, a communication unit 13, a display unit 14, an operating unit 15, a camera 16, and a current date and time acquisition unit 17. The units are connected by a bus 18.

The CPU 10 develops, in a work area of the RAM 11, a program stored in a program storage unit 121 of the storage unit 12, and a program downloaded from the server apparatus 2, and executes various processes in accordance with the developed programs.

For example, the CPU 10 of the tablet terminal 1A functions as parent account creation unit, child account creation unit, login unit, selection unit, manual upload unit, automatic upload unit, setting unit, and download unit by executing a growth recording process A described below.

For example, the CPU 10 of the smartphone 1B functions as parent account creation unit, login unit, manual upload unit, and download unit by executing a growth recording process B described below.

For example, the CPU 10 of the PC 1C functions as parent account creation unit, login unit, manual upload unit, and download unit.

The RAM 11 is volatile memory, and includes the work area that stores various programs to be executed by the CPU 10, data related to the various programs, and the like.

The storage unit 12 is configured of an HDD (Hard Disk Drive), nonvolatile semiconductor memory, or the like. For example, as illustrated in FIG. 1, the storage unit 12 is provided with the program storage unit 121.

A system program and various process programs that are executed by the CPU 10, data necessary to execute these programs, and the like are stored in the program storage unit 121. For example, in addition to the system program, a Web browser, and a growth recording application program (hereinafter referred to as the growth recording app) to execute the growth recording process according to the type of the information processing apparatus 1 if the type is the tablet terminal 1A or the smartphone 1B are stored in the program storage unit 121. The growth recording app is downloaded from the server apparatus 2 and stored in advance. The growth recording app corresponding to the tablet terminal 1A is referred to as the growth recording app A, and the growth recording app corresponding to the smartphone 1B as the growth recording app B.

These programs are stored in the program storage unit 121 in a format of a computer-readable program code. The CPU 10 sequentially executes operations in accordance with the program code.

Moreover, terminal type information indicating the type of its own apparatus, still image data, video data, and the like are stored in the storage unit 12.

The communication unit 13 is configured of a wireless LAN module, a network card, or the like, and connects to and communicates with an external apparatus such as the server apparatus 2 via the communication network N to transmit and receive data.

The display unit 14 is configured of an LCD (Liquid Crystal Display) or the like, and is display unit for performing various displays on a screen in accordance with display control signals from the CPU 10.

The operating unit 15 as operating unit accepts an input operation by a user and outputs the operation information to the CPU 10.

For example, if the type of the information processing apparatus 1 is the tablet terminal 1A or the smartphone 1B, the operating unit 15 includes, for example, a touch panel in which transparent electrodes are placed like a grid in such a manner as to cover the surface of the display unit 14, detects a position pressed by a hand finger, touch pen, or the like, and outputs the position information as operation information to the CPU 10. Moreover, the operating unit 15 includes various function keys and a shutter key, accepts the input of a press of each key by the user, and outputs the operation information to the CPU 10.

For example, if the information processing apparatus 1 is the PC 1C, the operating unit 15 is configured including a keyboard having character input keys, numeric input keys, various function keys, and the like, and a pointing device such as a mouse. The operating unit 15 outputs a key press signal obtained by performing a press operation by the keyboard, and a signal of an operation by the mouse as input signals to the CPU 10.

The camera 16 includes a lens, a diaphragm, and an imaging device such as a CCD (Charge Coupled Device) or CMOS (Complementary Metal Oxide Semiconductor). The camera 16 forms an optical image of a subject on the imaging device, and outputs the image as an electric signal to the CPU 10.

The current date and time acquisition unit 17 is configured of an RTC (Real Time Clock) or the like, measures the current date and time and outputs it to the CPU 10.

### <Configuration of Server Apparatus 2>

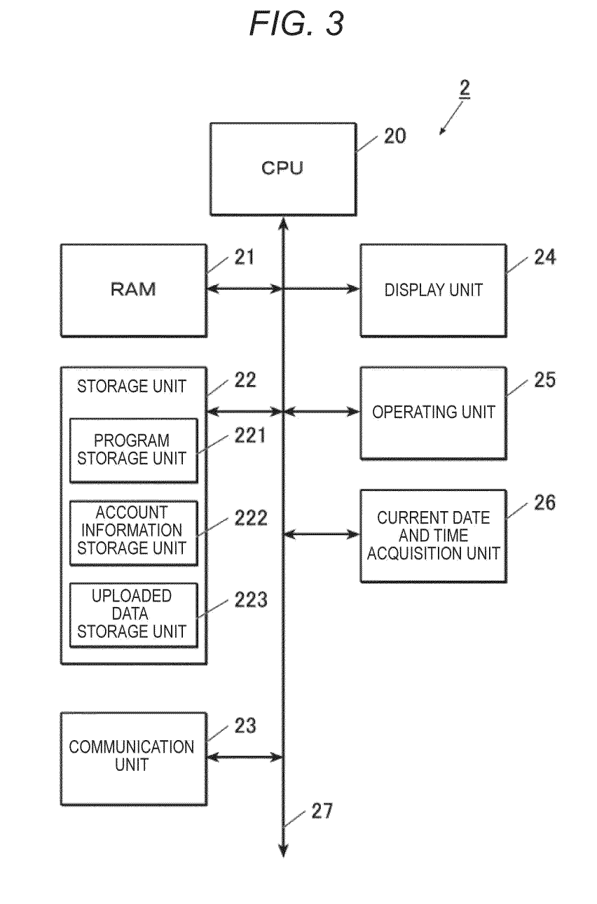

FIG. 3 illustrates an example of a functional configuration of the server apparatus 2. As illustrated in FIG. 3, the server apparatus 2 is configured including a CPU 20, RAM (Random Access Memory) 21, a storage unit 22, a communication unit 23, a display unit 24, an operating unit 25, and a current date and time acquisition unit 26. The units are connected by a bus 27.

The CPU 20 reads a program stored in the storage unit 22, develops the program in a work area of the RAM 21, and executes various processes in accordance with the developed program.

The RAM 21 is volatile memory, and includes the work area in which various programs to be executed by the CPU 20, data related to these programs, and the like are stored.

The storage unit 22 is configured of an HDD (Hard Disk Drive), nonvolatile semiconductor memory, or the like. For example, as illustrated in FIG. 3, the storage unit 22 is provided with a program storage unit 221, an account information storage unit 222, and an uploaded data storage unit 223.

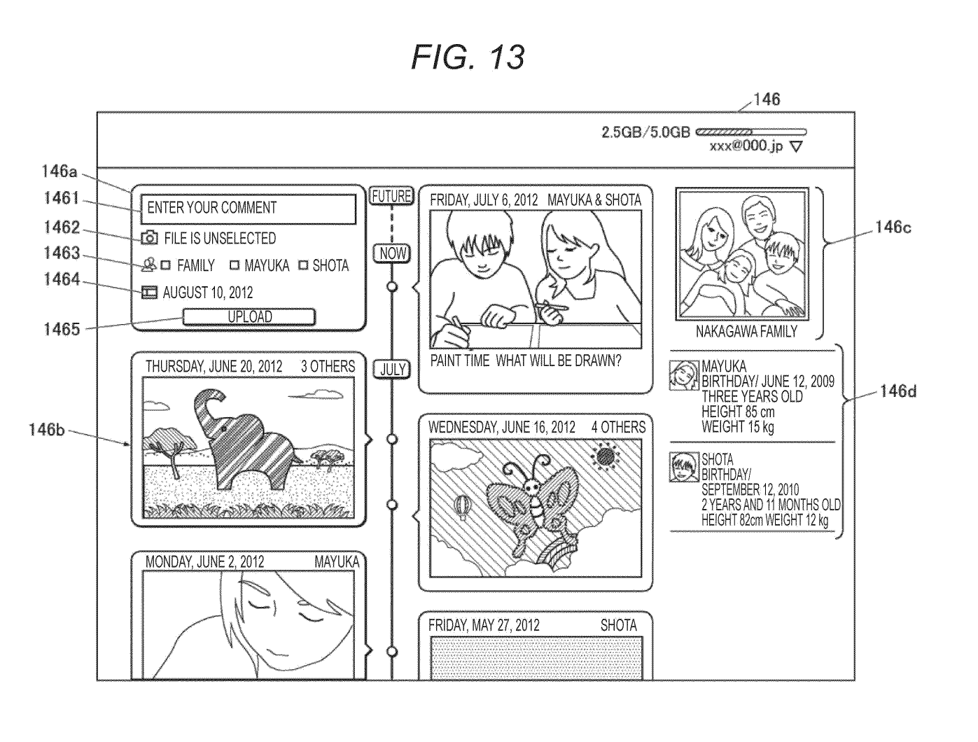

A system program and various process programs that are executed by the CPU 20, data necessary to execute these programs, and the like are stored in the program storage unit 221. For example, a program for creating a Web app for displaying a Web screen 146 (see FIG. 13) is associated with the type of the information processing apparatus 1 and stored by the type of each apparatus in the program storage unit 221. Moreover, a program to be provided to the information processing apparatus 1 according to the type of each apparatus, such as the growth recording app, is stored in the program storage unit 221 in association with the type of the information processing apparatus 1. These programs are stored in a format of a computer-readable program code in the program storage unit 221.

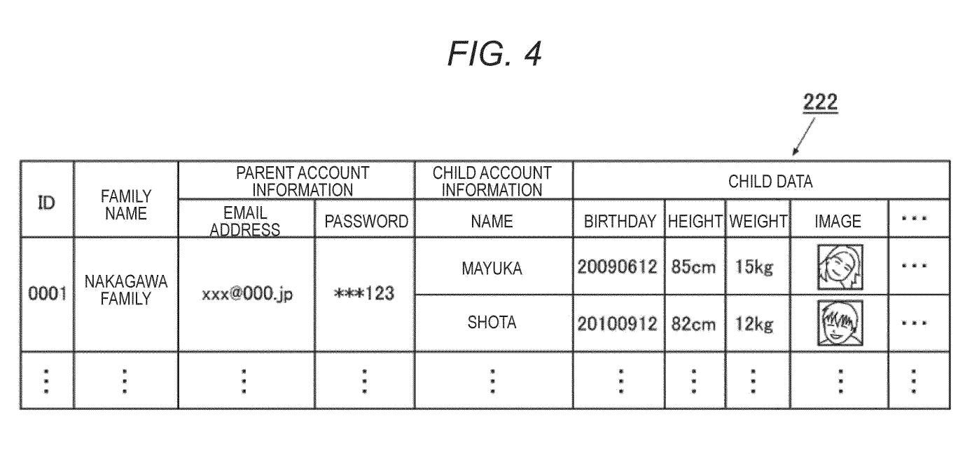

User information including a plurality of kinds of account information of users having a right to access the server apparatus 2 is stored in the account information storage unit 222. In the embodiment, the plurality of kinds of account information is, for example, parent account information as first account information, and child account information as second account information. FIG. 4 illustrates an example of data storage of the account information storage unit 222. As illustrated in FIG. 4, an ID, the parent account information (identification information (for example, email address and password)), the child account information (identification information (for example, name)), and a child's data corresponding to each child account (for example, birthday, height, weight, and image) are associated and stored in the account information storage unit 222 for each family being users.

The parent account here is a right to access the server apparatus 2, the right having been granted to a parent user. The parent account information is information, assigned to the parent user having the right to access the server apparatus 2, for identifying (authenticating) the parent. The child account is a right to access the server apparatus 2, the right having been granted to the child user. The child account information is information, assigned to the child user having the right to access the server apparatus 2, for identifying his/her parent. The child account is positioned under (associated with) the parent account. The child account cannot be created without the parent account. If the parent account has logged in, the child account becomes available. One family can register one parent account, and a plurality of child accounts.

Data uploaded from the information processing apparatus 1 (for example, drawing data, comment data, photograph data, and video data) is associated with the parent account information, the account information (in a case of drawing data) or attribute information (in a case of data other than drawing data, the details of which are described below) of a child user who has uploaded the data, and date information, and stored in the uploaded data storage unit 223.

The communication unit 23 is configured of a network card or the like, and connects to and communicates with an external apparatus such as the information processing apparatus 1 via the communication network N to transmit and receive data.

The display unit 24 is configured of an LCD (Liquid Crystal Display) or the like, and performs various displays on a screen in accordance with display control signals from the CPU 20.

The operating unit 25 is configured including a keyboard having character input keys, numeric input keys, various function keys, and the like, and a pointing device such as a mouse. The operating unit 25 outputs a key press signal obtained by performing a press operation by the keyboard, and a signal of an operation by the mouse as input signals to the CPU 20.

The current date and time acquisition unit 26 is configured of an RTC (Real Time Clock) or the like, measures a current date and time and outputs it to the CPU 20.

### <Operation of Data Management System 100>

Next, a description is given of the operation of the data management system 100 in the embodiment.

Firstly, the operation of the tablet terminal 1A is described.

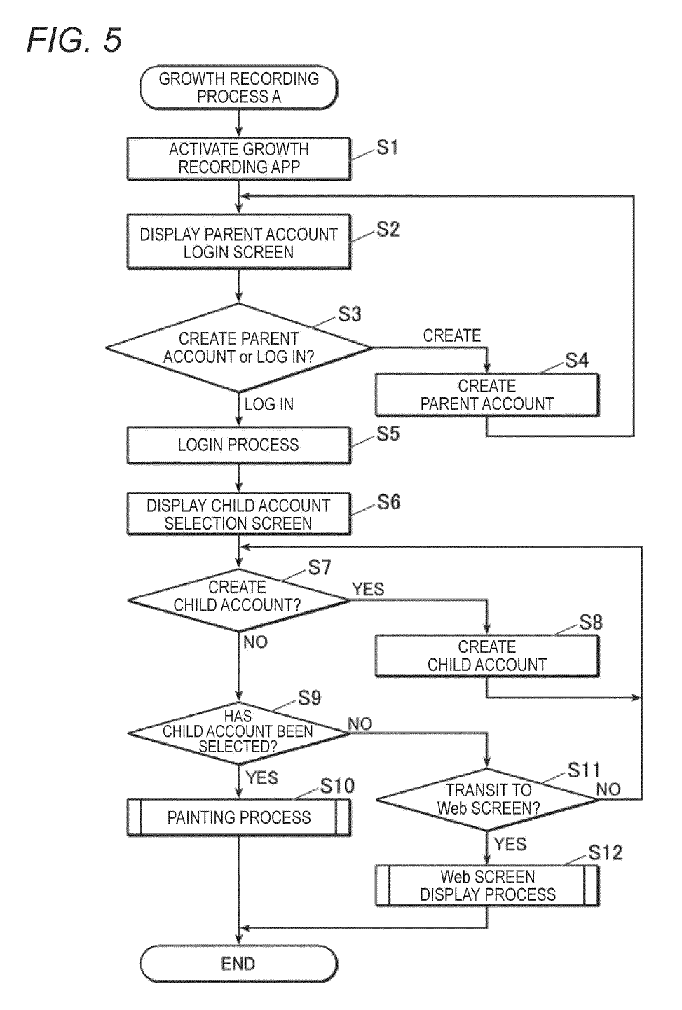

FIG. 5 illustrates a flowchart illustrating the growth recording process A to be executed by the tablet terminal 1A. The growth recording process A is executed in cooperation between the CPU 10 and the growth recording app A stored in the program storage unit 121 when the operating unit 15 instructs to activate the growth recording app A.

Firstly, the CPU 10 activates the growth recording app A (Step S1), and causes the display unit 14 to display a parent account login screen 141 (Step S2).

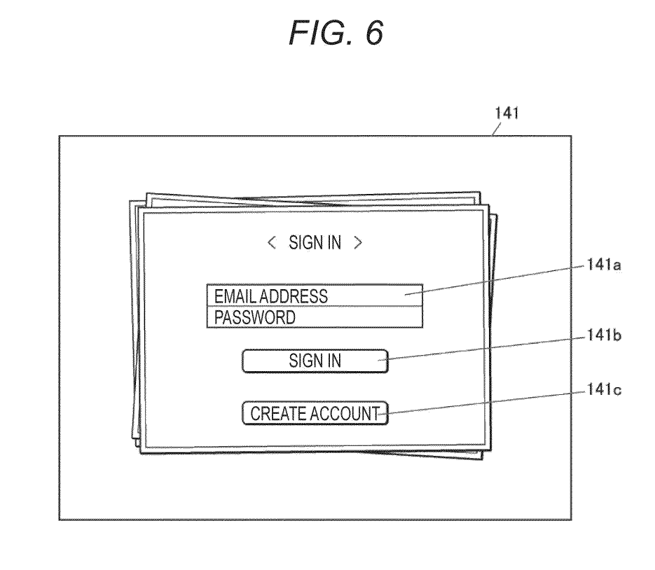

FIG. 6 illustrates an example of the parent account login screen 141. As illustrated in FIG. 6, the parent account login screen 141 is provided with a parent account input area 141a for inputting a parent account, a login button 14 lb for instructing a login (signing in) with the account input in the parent account input area 141a, and an account creation button 141c for instructing to create a parent account when there is no parent account. When the operating unit 15 detects a press on the parent account input area 141 a, the CPU 10 displays the keyboard and the like, and enables the input of a parent account.

Next, the CPU 10 judges whether the operating unit 15 has detected a press of the account creation button 141c, or has detected an input in the parent account input area 141a and a press of the login button 141b (Step S3).

If having judged that the operating unit 15 detected a press of the account creation button 141c (Step S3; CREATE), the CPU 10 displays a parent account creation screen (not illustrated) on the display unit 14, creates a parent account in accordance with the input by the operating unit 15 (Step S4), and returns to Step S2.

The parent account creation screen is a screen on which, for example, input fields of parent account information (for example, identification information (here, an email address and a password) unique to a parent user), an input field of a family name, a confirmation button, and the like are displayed. For example, in Step S4, when the operating unit 15 fills in the input fields of the parent account creation screen, and presses the confirmation button, the CPU 10 causes the communication unit 13 to transmit the parent account information and the like, which has been input in the input fields, to the server apparatus 2. When the communication unit 23 receives the parent account information and the like from the tablet terminal 1A, the CPU 20 of the server apparatus 2 stores the received parent account information and family name in the account information storage unit 222, and transmits an account creation completion notification to the information processing apparatus 1.

On the other hand, if having judged that the operating unit 15 detected an input in the parent account input area 141a and a press of the login button 14 lb on the parent account login screen 141 (Step S3; LOG IN), the CPU 10 performs a login process based on the parent account (Step S5).

In Step S5, specifically, the CPU 10 causes the communication unit 13 to transmit, to the server apparatus 2, the parent account information input in the parent account input area 141 a, and terminal type information indicating the terminal type of its own apparatus, and makes a login request to the server apparatus 2. If the communication unit 23 receives the parent account information, the terminal type information, and the login request from the tablet terminal 1A, the CPU 20 of the server apparatus 2 checks them against parent account information stored in the account information storage unit 222. If parent account information agreeing with the received parent account information exists in the account information storage unit 222, the CPU 20 grants access to the parent account and a child account corresponding to the parent account, and transmits an access permission notification to the tablet terminal 1A while transmitting, to the tablet terminal 1A, data (for example, the child account information and the child's image) necessary upon execution of the growth recording app. The information of the parent account to which access has been granted, and the terminal type information are stored and managed in the RAM 21 of the server apparatus 2 until logging out. Moreover, the information is also similarly stored and managed in the RAM 11 in the tablet terminal 1A.

If the access permission is notified, the CPU 10 selects the logged in parent account as the account to use.

If the login process ends, the CPU 10 displays a child account selection screen 142 on the display unit 14 (Step S6).

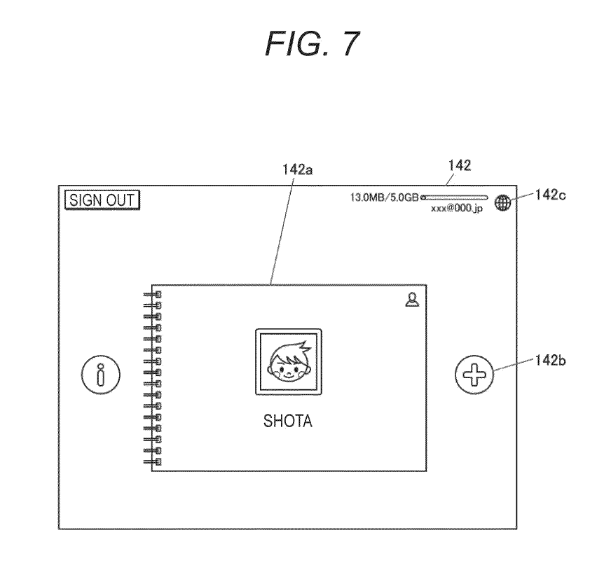

FIG. 7 illustrates an example of the child account selection screen 142. As illustrated in FIG. 7, the child account selection screen 142 is provided with a child account list 142a, a child account creation button 142b, and a Web screen transition button 142c. The child account list 142a is an area to display a list of information on child accounts corresponding to the logged in parent account. Any from the list is pressed and accordingly it can be selected as the child account to be used. FIG. 7 illustrates a case where there is one child account. If there is no child account corresponding to the parent account, the child account list 142a is not displayed. The child account creation button 142b is a button for instructing to create a child account. The Web screen transition button 142c is a button for instructing to transit to the Web screen 146 (see FIG. 13) for viewing and posting the child's growth records.

If the operating unit 15 has detected a press of the child account creation button 142b on the child account selection screen 142 (Step S7; YES), the CPU 10 creates a child account (Step S8), and returns to Step S7. Specifically, the CPU 10 displays an input area of new child account information (name) and a confirmation button on the child account selection screen 142 and, when the operating unit 15 inputs the new child account information and presses the confirmation button, associates the input child account information with the parent account information, and transmits the information to the server apparatus 2. If the communication unit 23 receives the child account information and the parent account information from the tablet terminal 1A, the CPU 20 of the server apparatus 2 stores the received child account information in a child account information area of a record related to the received parent account information in the account information storage unit 222. A child account creation completion notification is transmitted to the information processing apparatus 1.

If the operating unit 15 has detected the selection of a child account on the child account selection screen 142 (Step S7; NO and Step S9; YES), the CPU 10 selects the selected child account as the account to use, and executes a painting process (Step S10). The information of the selected account is stored in the RAM 11.

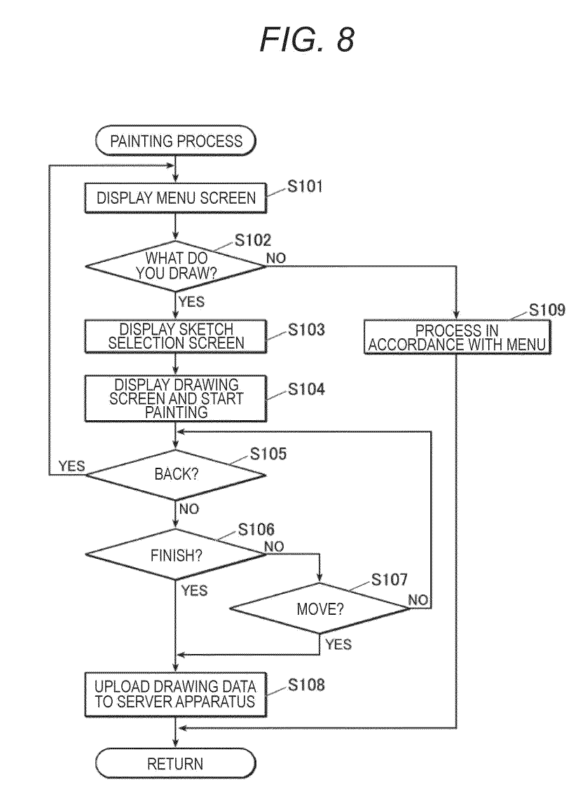

FIG. 8 illustrates the flowchart of the painting process executed in Step S10. The painting process is executed in cooperation between the CPU 10 and the growth recording app A.

Firstly, the CPU 10 displays a menu screen 143 on the display unit 14 (Step S101).

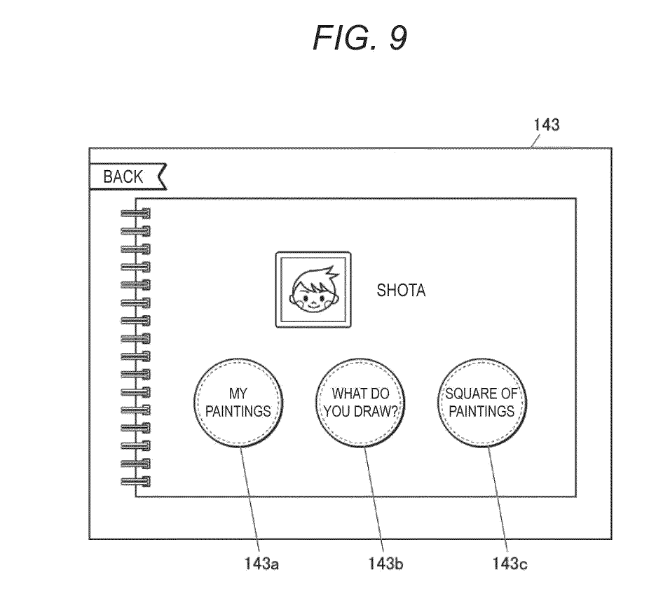

FIG. 9 illustrates an example of the menu screen 143. As illustrated in FIG. 9, a “MY paintings” button 143a for instructing to view a picture drawn by the user himself/herself (the child user having the selected child account) in the past, a “what do you draw?” button 143b for instructing to paint a picture, a “square of paintings” button 143c for instructing to view paintings of other children are displayed on the menu screen 143.

If the operating unit 15 has detected a press of the “what do you draw?” button 143b (Step S102; YES), the CPU 10 displays a sketch selection screen 144 on the display unit 14, and accepts the selection of a sketch (Step S103).

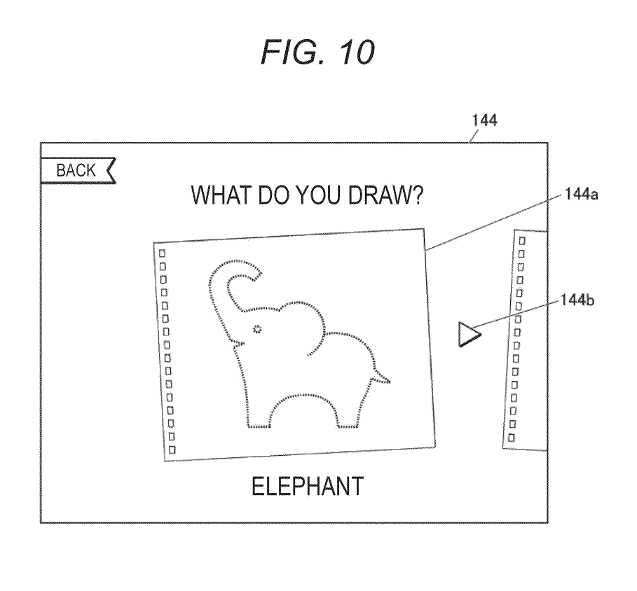

FIG. 10 illustrates an example of the sketch selection screen 144. As illustrated in FIG. 10, a sketchbook 144a where sketches for painting are drawn (or the blank sketchbook 144a), and a right arrow button 144b are displayed on the sketch selection screen 144. Whenever the operating unit 15 detects a press of the right arrow button 144b, a sketch to be displayed is switched and displayed. If the operating unit 15 detects a press of the sketchbook 144a, a sketch displayed in the pressed sketchbook 144a can be selected.

If the sketch is selected, the CPU 10 displays a drawing screen 145 on the display unit 14, and starts painting (Step S104).

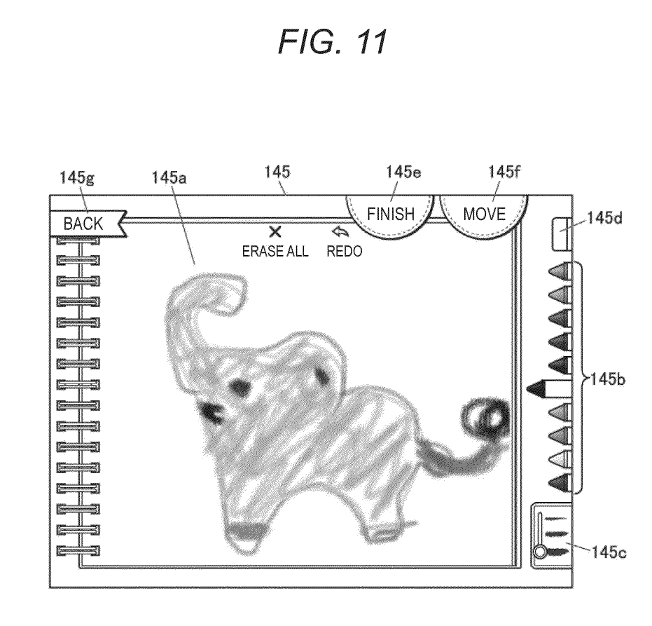

FIG. 11 illustrates an example of the drawing screen 145. As illustrated in FIG. 11, a drawing area 145a, crayons 145b, a line type selection button 145c, an eraser 145d, a “finish” button 145e, a “move” button 145f, a “back” button 145g, and the like are provided on the drawing screen 145. The “finish” button 145e is a button to be pressed when a picture is finished. The “move” button 145f is a button to instruct to move the finished picture. The “back” button 145g is a button to instruct to return to the menu screen 143. The child user having the selected child account presses the crayon 145b and the line type selection button 145c to select the crayon and the line type, and moves the finger over the drawing area 145a. Accordingly, the child user can draw a picture in the drawing area 145a.

If the operating unit 15 detects a press of the “back” button 145g, the CPU 10 returns the process of Step S101. If the operating unit 15 detects a press of the “finish” button 145e or the “move” button 145f (Step S106; YES or Step S107; YES), the CPU 10 judges that it has been detected that the picture (drawing data) is finished, and associates the drawing data of the picture drawn in the drawing area 145a with the parent account information, the information of the selected child account, and date information (information of the date when the press of the “finish” button 145e or the “move” button 145f was detected, that is, the finish date). The CPU 10 uploads (transmits) the drawing data to the server apparatus 2 by the communication unit 13 (Step S108), and ends the painting process.

In the server apparatus 2, when the communication unit 23 receives the drawing data and the like from the tablet terminal 1A, the CPU 20 associates the received drawing data with the received parent account information, child account information, and date information, and stores the drawing data in the uploaded data storage unit 223.

On the other hand, if a press of the menu button other than the “what do you draw?” button 143b in Step S102 (Step S102; NO), the CPU 10 executes a process in accordance with the menu (Step S109), and ends the painting process.

In this manner, in the painting process, at a timing when the child having the selected account draws a picture, and a press of the “finish” button 145e indicating that the picture is finished, or the “move” button 145f that instructs to move the finished picture, has been detected, the drawing data of the picture drawn in the drawing area 145a is automatically uploaded to the server apparatus 2. In other words, when the child account has been selected in the tablet terminal 1A, even if the user does not perform operations of selecting data to upload and instructing to upload, the upload to the server apparatus 2 can be automatically performed.

Return to FIG. 5. If the operating unit 15 has detected a press of the Web screen transition button 142c on the child account selection screen 142 (Step S7; NO, Step S9; NO, and Step S11; YES), the CPU 10 executes a Web screen display process (Step S12).

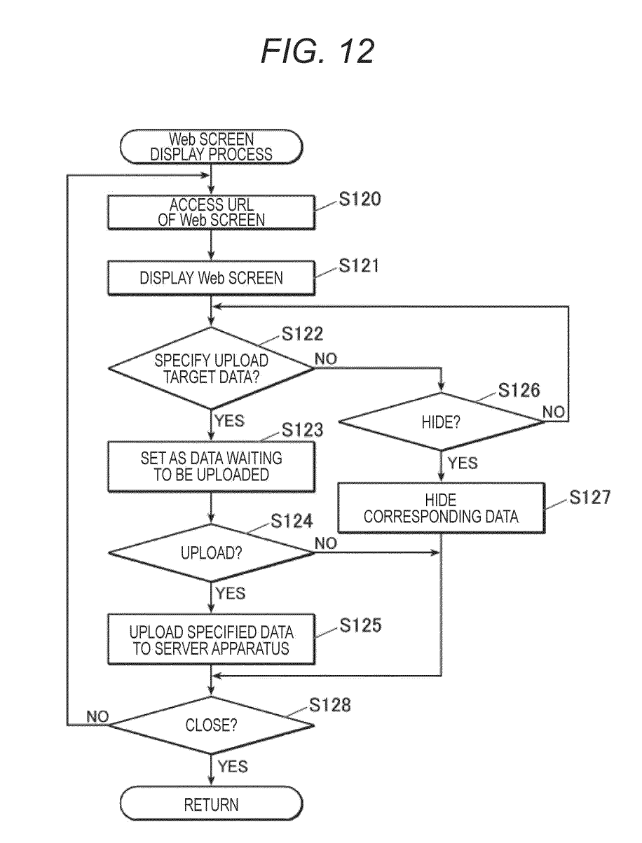

FIG. 12 illustrates the flowchart of the Web screen display process executed in Step S12. The Web screen display process is executed in cooperation between the CPU 10, and the growth recording app A and the Web browser.

Firstly, the CPU 10 accesses a URL (Uniform Resource Locator) of the Web screen 146 (see FIG. 13) based on the account selected by the communication unit 13 (that is, the parent account), and downloads, from the server apparatus 2, a program (Web app) in which screen information necessary to display the Web screen 146 on the Web browser, and a process to be executed on the Web screen 146 are described (Step S120).

The CPU 20 of the server apparatus 2 creates a Web app in which the screen information necessary to display the Web screen 146 on the Web browser, and the process to be executed on the Web screen 146 are described, based on the data associated with the received parent account information and stored in the uploaded data storage unit 223, and the terminal identification information at the time of logging in. The CPU 20 transmits the Web app to the tablet terminal 1A.

Next, the CPU 10 displays the Web screen 146 on the display unit 14 (Step S121).

FIG. 13 illustrates an example of the Web screen 146. As illustrated in FIG. 13, an upload specification area 146a, a chronological display area 146b, a family information area 146c, a child information area 146d, and the like are displayed on the Web screen 146.

The upload specification area 146a is an operation area for specifying (inputting) upload target data, its attribute, and date information, and uploading the specified data. The upload specification area 146a is provided with a comment input field 1461, a photograph/video specification field 1462, an attribute specification field 1463, a date specification field 1464, an upload button 1465, and the like.

The chronological display area 146b is an area to arrange and display data (drawing data, comments, photographs, videos, and the like) saved in chronological order in the uploaded data storage unit 223 of the server apparatus 2 in association with the logged in parent account.

The family information area 146c is an area indicating a family name and the like.

The child information area 146d is an area to display information of child users having child accounts. A “hide” button is provided in association with the information of each child user displayed in the child information area 146d. The “hide” button is pressed and accordingly the information of a child user corresponding to the pressed button can be prevented from showing up in the chronological display area 146b.

If the operating unit 15 detects the specification operation of the upload target data on the Web screen 146 (Step S122; YES), the CPU 10 sets data waiting to be uploaded in response to the detected operation (Step S123).

For example, if the operating unit 15 detects a press of the comment input field 1461 on the Web screen 146, the CPU 10 displays a keyboard in the vicinity of the upload specification area 146a, and sets the comment input by presses on the keyboard as the data waiting to be uploaded.

If the operating unit 15 detects a press of the photograph/video specification field 1462, the CPU 10 displays a list of folders in the storage unit 22, the folders containing the saved photographs and video. If the operating unit 15 specifies an upload target data file from the folders, the CPU 10 sets the specified file as the data waiting to be uploaded.

If the operating unit 15 detects a press of any of attribute checkboxes in the attribute specification field 1463, account information (parent account information in the case of family) corresponding to an attribute of the pressed checkbox is set as the attribute information of the upload target data.

If the operating unit 15 presses the date specification field 1464, the CPU 10 displays a calendar, and sets a date specified on the calendar as date information corresponding to the upload target data.

Not only a past date but also a future date can be specified in the date specification field 1464. For example, it is possible to form and display a timeline from the past to the future of the family in the chronological display area 146b by uploading comments, school photograph data, and the like in association with dates of the child's entrance ceremony (schedule), graduation ceremony (schedule), and the like.

If the operating unit 15 detects a press of the upload button 1465 (Step S124; YES), the CPU 10 associates the parent account information, the attribute information, and the date information with the data waiting to be uploaded set in Step S123, uploads (transmits) the data to the server apparatus 2 by the communication unit 13 (Step S125), and shifts to Step S128. The CPU 10 associates a current date with data that is not associated with date information, and uploads the data.

In the server apparatus 2, the data received by the communication unit 23 is associated with account information and date information that correspond to the parent account information and the attribute information, and stored in the uploaded data storage unit 223.

On the other hand, if the operating unit 15 detects a press of the “hide” button on the Web screen 146 (Step S122; NO and Step S126; YES), the data related to a user corresponding to the detected “hide” button (the data associated with child account information of the user) is hidden (Step S127). Execution shifts to Step 5128.

If the operating unit 15 detects an operation to close the Web screen 146 in Step S128 (Step S128; YES), the CPU 10 ends the Web screen display process.

Next, the operation of the smartphone 1B is described.

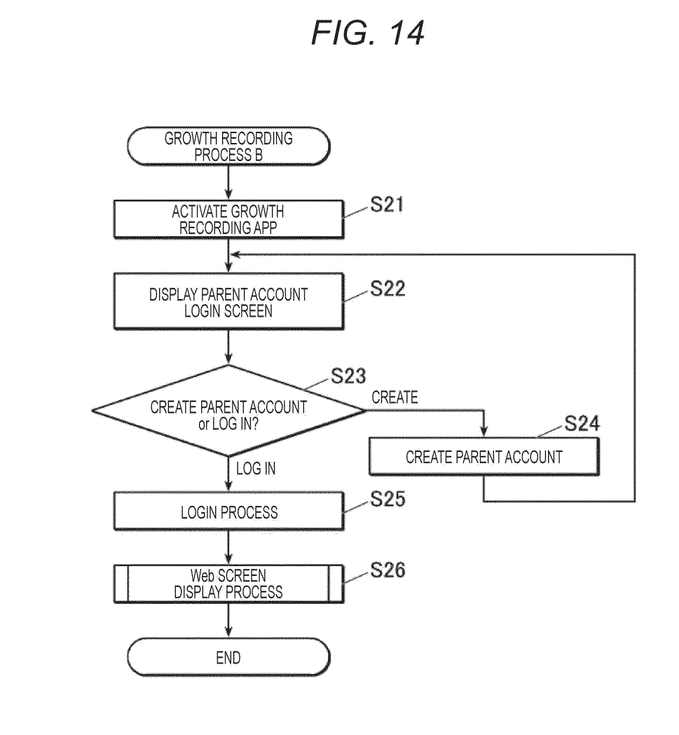

FIG. 14 illustrates the flowchart of the growth recording process B to be executed by the smartphone 1B. The growth recording program B is executed in cooperation between the CPU 10 and the growth recording app B stored in the program storage unit 121 when the operating unit 15 instructs to activate the growth recording app B in the smartphone 1B.

Firstly, the CPU 10 activates the growth recording app B (Step S21), and causes the display unit 14 to display the parent account login screen 141 (see FIG. 6) (Step S22).

Next, the CPU 10 judges whether or not the operating unit 15 has detected a press of the account creation button 141c, or an input in the parent account input area 141a and a press of the login button 141b, on the parent account login screen 141 (Step S23).

If having judged that the operating unit 15 detected a press of the account creation button 141 c (Step S23; CREATE), the CPU 10 displays a parent account creation screen (not illustrated) on the display unit 14, creates a parent account in accordance with the input by the operating unit 15 (Step S24), and returns to Step S22. The creation of a parent account is similar to the one described in Step S4 of the above-mentioned FIG. 4. Accordingly, the description is invoked.

On the other hand, if having judged that the operating unit 15 detected an input in the parent account input area 141 a and a press of the login button 14 lb on the parent account login screen 141 (Step S23; LOG IN), the CPU 10 performs the login process with the parent account (Step S25). The login process of Step S25 is similar to the one described in Step S5 of FIG. 5. Accordingly, the description is invoked.

When the login process ends, the CPU 10 executes a Web screen display process (Step S26), and ends the growth recording process B. The Web screen display process is similar to the one described using FIG. 12 except a difference in the operating subject (that is the smartphone 1B). Accordingly, the description is omitted. However, the server apparatus 2 transmits a Web app in accordance with the terminal type information transmitted together with the parent account information at the time of logging in to the information processing apparatus 1 that has logged in. Accordingly, the display forms (aspect ratio, arrangement, and the like) of the Web screen 146 are slightly different from the one illustrated in FIG. 13.

Next, the operation of the PC 1C is described.

The operation of the PC 1C illustrated below is executed in cooperation between the CPU 10 and the Web browser stored in the program storage unit 121.

In the PC 1C, when the Web browser is activated, and the URL of the Web screen 146 is specified by the operating unit 15, the CPU 10 causes the communication unit 13 to access the server apparatus 2 based on the URL.

In the server apparatus 2, when an access from the PC 1C is received, the communication unit 23 transmits a login screen to the server apparatus 2. The login screen is a similar screen to the parent account login screen illustrated in FIG. 6.

If the communication unit 13 receives the login screen, the CPU 10 of the PC 1C displays the received login screen on the display unit 14, and creates an account or performs the login process based on the input on the login screen by the operating unit 15. The creation of an account and the login process are similar to the above-mentioned ones. Accordingly, the descriptions are omitted.

When the login is permitted, the CPU 20 of the server apparatus 2 creates a Web app in which screen information necessary to display the Web screen 146 on the Web browser, and a process to be executed on the Web screen 146 are described, based on the data stored in the uploaded data storage unit 223 in association with the parent account information received in the login process, and the terminal type information at the time of logging in. The CPU 20 transmits the Web app to the PC 1C.

When the communication unit 13 has received, from the server apparatus 2, the Web app in which the screen information necessary to display the Web screen 146 on the Web browser, and the process to be executed on the Web screen 146 are described, the PC 1C displays the Web screen 146 on the display unit 14 based on the Web app and executes the Web screen display process illustrated in FIG. 12 from Step S122.

As described above, according to the tablet terminal 1A of the embodiment, if the parent account has been selected as an account to be used, the CPU 10 uploads the data specified as the upload target by the operating unit 15 to the server apparatus 2 at the specified timing. If the child account has been selected as an account to be used, the CPU 10 automatically uploads predetermined data to the server apparatus 2 at a predetermined timing.

Therefore, if the account used is the parent account, data is uploaded in response to a manual operation. If the account used is the child account, predetermined data is automatically uploaded at a predetermined timing. Accordingly, for example, if the child is using a tablet terminal on the child account, predetermined data can be fully uploaded at a predetermined timing without troubling his/her parent. It becomes possible to efficiently upload the data in accordance with the account used.

Moreover, while one parent account can be created, one or a plurality of child accounts can be created. Accordingly, for example, if there is a plurality of children, a child account unique to each child is assigned to enable the upload and management of data.

Moreover, if a login is performed based on the parent account, it becomes possible to select the parent or child account. Accordingly, the need of the login operation on the child account can be eliminated.

Moreover, if upload is performed based on the parent account, when the operating unit 15 specifies date information for data specified as the upload target, the CPU 10 associates the upload target data with the specified date information and uploads the data to the server apparatus 2. If the operating unit 15 has not specified date information, the upload target data is associated with a current date and uploaded to the server apparatus 2. Moreover, if upload is performed based on the child account, predetermined data to be uploaded is associated with a current date and uploaded to the server apparatus 2.

Therefore, if the parent account is being used, desired date information can be associated with the upload target data. If the child account is being used, it becomes possible to automatically associate a current date (that is, an upload date) with predetermined upload target data.

Moreover, it is possible to download, from the server apparatus 2, screen information for arranging and displaying the data uploaded to the server apparatus 2 in chronological order, and display the downloaded screen information on the display unit 14. Therefore, it becomes possible for the user to arrange and view the data uploaded to the server apparatus 2 in chronological order.

Moreover, if the child account has been selected, drawing data is automatically uploaded at a timing when the finish of the drawing data is detected. Accordingly, it becomes possible to fully upload the drawing data painted by the child to the server apparatus 2 without performing operations such as the specification of data to upload and an instruction to upload, and cause the server apparatus 2 to manage the drawing data.

Moreover, the server apparatus 2 permits access on both the parent account and the child account by a login based on the parent account. Accordingly, the login operation with the child account becomes unnecessary.

Moreover, if the information processing apparatus 1 is a specific type of terminal such as the tablet terminal 1A, the selection of the child account and the above automatic data upload become possible. Accordingly, it becomes possible to restrict the type of apparatus that can perform automatic upload with the child account.

The description content in the embodiment is a preferred example of the data management system 100. The description content is not limited to this.

For example, in the embodiment, the description has been given taking an example of the case where the parent and child (family) uses the data management system 100, the parent uses the parent account, and the child uses the child account. However, the parent and child accounts are not limited to those actually used by the parent and child. For example, a teacher may use the parent account and a student (child) may use the child account at a preschool, school, or the like.

Moreover, in the embodiment, the description has been given taking an example of the case of uploading drawing data of a child's painting. However, data is not limited to this. For example, other data such as data of a child's characters and sentences may be uploaded.

Moreover, in the embodiment, drawing data is automatically uploaded at timings such as when the finish of the drawing data is detected. However, timings are not limited to this. The drawing data may be automatically uploaded at predetermined time intervals.

Moreover, it is also possible to apply nonvolatile memory such as flash memory, and a portable recording medium such as a CD-ROM, in addition to ROM, a hard disk, and the like, as a computer-readable medium in which the programs to execute the above processes are stored. Moreover, a carrier wave is also applied as a medium that provides the program's data via a predetermined communication line.

In addition, the detailed configuration and operation of each apparatus configuring the data management system can also be changed within the scope that does not depart from the spirit of the invention, as appropriate.

What is claimed is:

1. An information processing apparatus comprising:
a control unit configured to create a first account to access a storage unit for managing data, and a second account corresponding to the first account; and
a storage control unit configured to upload data specified as an upload target to the storage unit at a specified timing upon use of the first account, and automatically upload predetermined data to the storage unit at a predetermined timing upon use of the second account.

2. The information processing apparatus according to claim 1, wherein
a number of the first accounts is one, and
a number of the second accounts is one or more.

3. The information processing apparatus according to claim 1, wherein the control unit performs a login process based on the first account and, upon a login based on the first account, selects the first or second account.

4. The information processing apparatus according to claim 1, wherein
the control unit sets specified date information for the data specified as the upload target, and
when the control unit has set the date information, the storage control unit associates the upload target data with the set date information and uploads the data to the storage unit.

5. The information processing apparatus according to claim 1, wherein the storage control unit associates the predetermined data with a current date and uploads the predetermined data to the storage unit upon the use of the second account.

6. The information processing apparatus according to claim 4, further comprising a display unit configured to display screen information for arranging and displaying the data uploaded to the storage unit in chronological order, wherein the screen information is downloaded by the storage control unit from the storage unit.

7. The information processing apparatus according to claim 1, wherein
the predetermined data is drawing data input in a case where the second account has been selected, and
the predetermined timing is a timing when a finish of the drawing data has been detected.

8. The information processing apparatus according to claim 1, wherein
the first account is a parent account, and
the second account is a child account.

9. The information processing apparatus according to claim 1, wherein the storage unit is a server apparatus for managing data.

10. A data upload method comprising the steps of:
creating a first account to access a storage unit for managing data;
creating a second account corresponding to the first account;
uploading, to the storage unit, data specified as an upload target at a predetermined timing upon use of the first account; and
automatically uploading predetermined data to the storage unit at a predetermined timing upon use of the second account.

11. A computer-readable medium for causing a computer to execute:
a first account creation process of creating a first account to access a storage unit for managing data;
a second account creation process of creating a second account corresponding to the first account;
a manual upload process of uploading data specified as an upload target by an operating unit to the storage unit at a specified timing upon use of the first account; and
an automatic upload process of automatically uploading predetermined data to the storage unit at a predetermined timing upon use of the second account.
